(19) United States
(12) Patent Application Publication
(10) Pub. No.: US 2015/0161589 A1
(43) Pub. Date: Jun. 11, 2015

(54) TIPPING AN INDIVIDUAL USING A SMART PHONE

(71) Applicant: Jeffrey J. Snider, Pleasant Grove, UT (US)

(72) Inventor: Jeffrey J. Snider, Pleasant Grove, UT (US)

(21) Appl. No.: 14/562,204

(22) Filed: Dec. 5, 2014

Related U.S. Application Data
(60) Provisional application No. 61/912,353, filed on Dec. 5, 2013.

(51) Int. Cl. G06Q 20/32; G06Q 20/40; G06Q 50/12; G06Q 20/10

(52) U.S. Cl. CPC G06Q 20/3276; G06Q 20/10; G06Q 20/40; G06Q 50/12

(57) ABSTRACT

A tip can be provided to an individual using a smart phone. A smart phone can be configured with an application that scans a code that can be worn by a service individual. The code can uniquely identify the service individual including the service individual's account. The application can also be configured with the user's payment account information to enable the application to initiate the transfer of a tip from the user's payment account to the service individual's account when the service individual's code is scanned. Accordingly, the user only needs to scan the code to provide a tip to the service individual. In this way, a tip of virtually any amount can be provided quickly and easily even when the user does not have any cash.

### CROSS-REFERENCE TO RELATED APPLICATIONS

This application claims the benefit of U.S. Provisional Patent Application No. 61/912,353 which was filed on Dec. 5, 2013.

### BACKGROUND

In many service-based industries, it is common to tip. In many cases such as when dining or receiving a spa treatment, the service is provided in conjunction with a bill. In these cases, it is easy to add the tip to the payment of the bill using a credit or debit card. In other cases such as with a concierge or valet, the service may be provided separate from any bill. In these cases, the tip is typically paid with cash. Unfortunately, many people do not carry sufficient cash to tip individuals a desirable amount. As a result, people often feel badly that they cannot tip more.

### BRIEF SUMMARY

The present invention extends to methods, systems, and computer program products for tipping an individual using a smart phone or other mobile computing device. A smart phone can be configured with an application that scans a code that can be worn by a service individual. The code can uniquely identify the service individual including the service individual's account. The application can also be configured with the user's payment account information to enable the application to initiate the transfer of a tip from the user's payment account to the service individual's account when the service individual's code is scanned. Accordingly, the user only needs to scan the code to provide a tip to the service individual. In this way, a tip of virtually any amount can be provided quickly and easily even when the user does not have any cash.

In one embodiment, the present invention is implemented as a method for providing a tip electronically using a mobile computing device. A mobile computing device of a user is used to scan a code that is associated with an account of an individual. The mobile computing device displays, to the user of the mobile computing device, an interface for receiving a tip amount to provide to the individual for services rendered by the individual to the user. The tip amount is then received from the user. The code and the tip amount are transferred to a server system to request the transfer of the tip amount from an account of the user to the account of the individual that is associated with the code.

In another embodiment, the present invention is implemented as a method for transferring a tip amount from a user's account to an account of an individual using a code associated with the individual. Account information for an account of an individual is received. Information identifying the individual is also received. An association between a code and the account of the individual is generated. The code is provided to the individual to allow the individual to display the code to a user to whom the individual provides services. In response to a user using a portable computing device to scan the code, the code is received along with a tip amount to transfer from an account of the user to the account of the individual. The information identifying the individual is transmitted to the portable computing device to be displayed in conjunction with a request to confirm that the tip amount should be transferred from the user's account to the account of the individual. In response to receiving confirmation from the user, the tip amount is caused to be transferred from the user's account to the account of the individual.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computing environment in which the present invention can be implemented;

FIG. 2 illustrates an example of how a user can use a smart phone to tip an individual;

FIG. 3 illustrates an example data structure that stores associations between codes and individuals;

FIG. 4 illustrates an example user interface that can be displayed on a smart phone to allow a user to specify an amount to tip;

FIG. 5 illustrates an example user interface that can be displayed on a smart phone to allow a user to provide confirmation prior to initiating the transfer of a tip; and

FIG. 6 illustrates a flowchart of an example process for creating an association between a QR code and an individual's account information and then using this association to transfer a tip to the individual's account.

### DETAILED DESCRIPTION

The present invention extends to methods, systems, and computer program products for tipping an individual using a smart phone or other mobile computing device. A smart phone can be configured with an application that scans a code that can be worn by a service individual. The code can uniquely identify the service individual including the service individual's account. The application can also be configured with the user's payment account information to enable the application to initiate the transfer of a tip from the user's payment account to the service individual's account when the service individual's code is scanned. Accordingly, the user only needs to scan the code to provide a tip to the service individual. In this way, a tip of virtually any amount can be provided quickly and easily even when the user does not have any cash.

In one embodiment, the present invention is implemented as a method for providing a tip electronically using a mobile computing device. A mobile computing device of a user is used to scan a code that is associated with an account of an individual. The mobile computing device displays, to the user of the mobile computing device, an interface for receiving a tip amount to provide to the individual for services rendered by the individual to the user. The tip amount is then received from the user. The code and the tip amount are transferred to a server system to request the transfer of the tip amount from an account of the user to the account of the individual that is associated with the code.

In another embodiment, the present invention is implemented as a method for transferring a tip amount from a user's account to an account of an individual using a code associated with the individual. Account information for an account of an individual is received. Information identifying the individual is also received. An association between a code and the account of the individual is generated. The code is provided to the individual to allow the individual to display the code to a user to whom the individual provides services. In response to a user using a portable computing device to scan the code, the code is received along with a tip amount to transfer from an account of the user to the account of the individual. The information identifying the individual is transmitted to the portable computing device to be displayed in conjunction with a request to confirm that the tip amount should be transferred from the user's account to the account of the individual. In response to receiving confirmation from the user, the tip amount is caused to be transferred from the user's account to the account of the individual.

Example Computing Architecture

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

Example Computing Environment

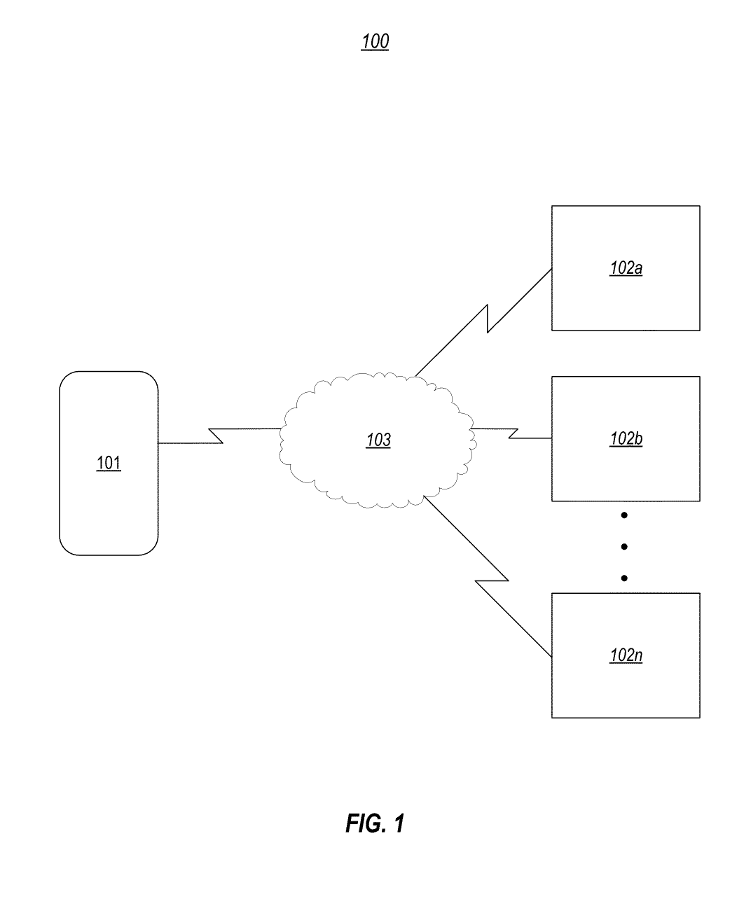

FIG. 1 illustrates an example computer environment 100 in which the present invention can be implemented. Computer environment 100 includes a mobile computing device 101 which may typically be a smart phone having a camera with which a code can be scanned. Mobile computing device 101 is interconnected via network 103 with various server systems 102a-102n. Server systems 102a-102n can represent the systems where a user's and a service individual's account information is stored as well as possibly other systems that are employed to perform a transfer of funds between accounts.

The specific manner in which funds are transferred between two accounts is not essential to the invention. Network 103 typically will be the internet although other networks can also be employed. For example, in a typical implementation, mobile computing device 101 will communicate with one or more of server systems 102a-102n using a Wi-Fi or cellular (e.g. 4G) connection. Also, although this specification will primarily refer to using a smart phone to tip an individual, any mobile computing device capable of performing the described functionality could also be used (e.g. a tablet).

Tipping an Individual Using a Smart Phone

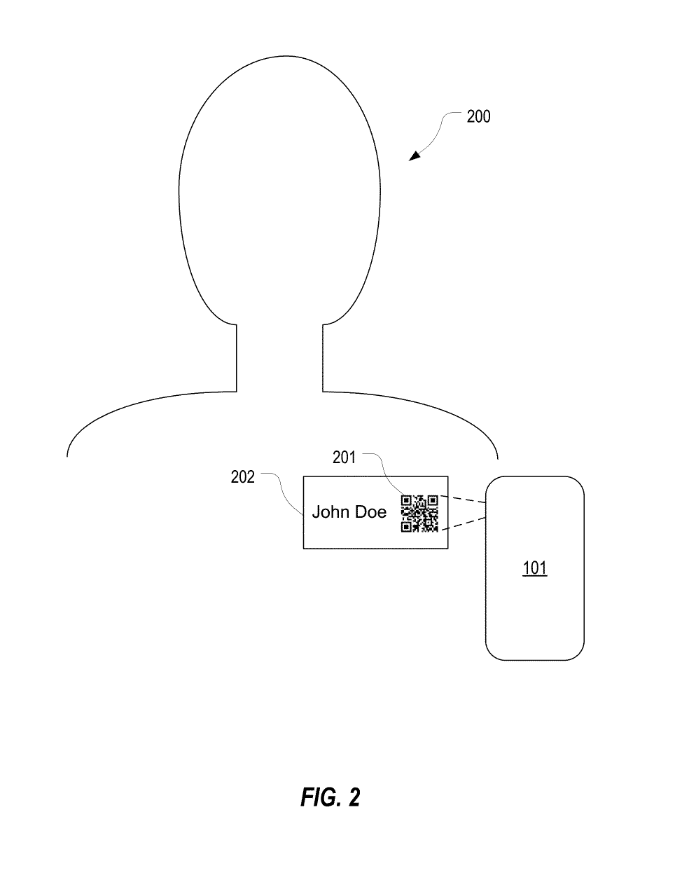

FIG. 2 illustrates an example of how a user can use his smart phone 101 to tip an individual 200. FIG. 2 represents a scenario where the individual wears a name badge 202 that includes a two dimensional barcode (or QR code) 201. Other types of scannable codes could also be used in the same manner as QR code 201.

QR code 201 is uniquely associated with individual 200. More specifically, QR code 201 can uniquely identify a bank account of individual 200. In this manner, by scanning QR code 201, an application executing on smart phone 101 can retrieve the necessary information for transferring a tip from a user's account to the individual's bank account.

In some embodiments, a database of QR codes can be maintained (e.g. on a server system with which smart phone 101 can communicate). Each of the QR codes in the database can be associated with a unique individual. The database can also store account information for each of the individuals. In such cases, when a user scans a QR code with a smart phone, an application on the smart phone can access the database to identify whether the QR code is defined in the database. If the QR code is defined in the database, the account information associated with the QR code can be used to initiate the transfer of a tip from the user's account to the account associated with the QR code.

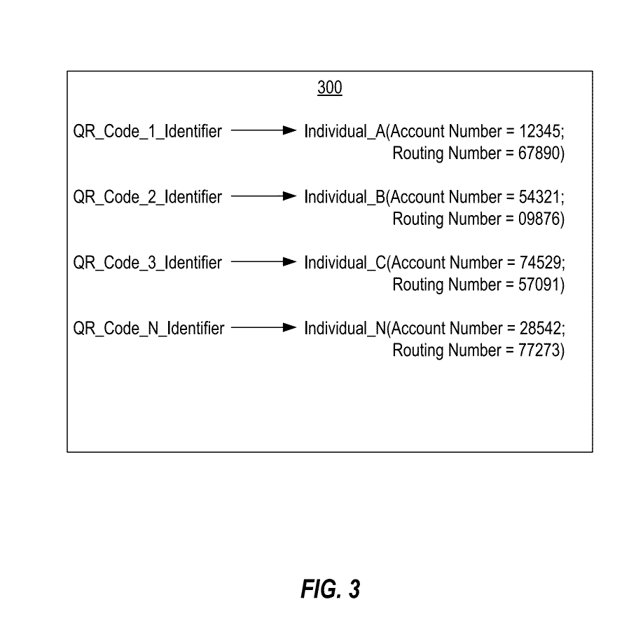

FIG. 3 illustrates an example data structure 300 that stores associations between QR codes and individuals. As shown, each QR code represents a unique identifier. When the QR code is scanned, the unique identifier for the QR code can be determined and used to query data structure 300 to obtain the account information associated with the QR code. Once obtained, the account information can be used to transfer a tip from the user's account to the account associated with the scanned QR code.

Accordingly, the present invention enables any individual to receive tips electronically by simply wearing or providing access to a QR code that has been associated with the individual and the individual's bank account (or other similar account). In some embodiments, the present invention can provide a website or other application where an individual can input his account information to receive a QR code that can be used to receive tips. For example, in response to receiving an individual's account information (e.g. bank account and routing number), a service can generate an association between the account information and a QR code. The associated QR code can then be provided to the individual. For example, the QR code can be displayed to allow the individual to print it. In some embodiments, the QR code can be printed as a sticker that can be adhered to an individual's name badge or other worn item. In this way, the QR code will be visible to users whom the individual assists thereby informing the users that the individual accepts tips electronically.

In some embodiments, the present invention can also store account information for users that may use their smart phones to tip an individual. For example, a user can input his bank account information or credit or debit card number which can then be stored for automatic retrieval when the user scans a QR code. In this manner, the user does not need to input this information when providing a tip. In some embodiments, the user can also input a default tip amount so that when a QR code is scanned, the default amount can automatically be transferred without requiring any input from the user. In other embodiments, after scanning a QR code, the user can be presented with the option to specify or select an amount to tip.

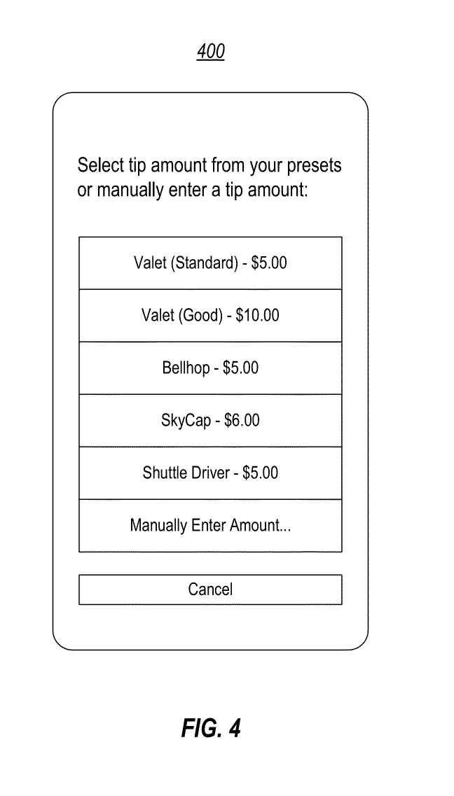

FIG. 4 illustrates an example of a user interface 400 that can be displayed on a smart phone to allow the user to specify an amount to tip. User interface 400 can be displayed before or after the user has scanned a QR code. As shown, user interface 400 provides various different amounts that can be selected for the tip including an option to manually enter an amount.

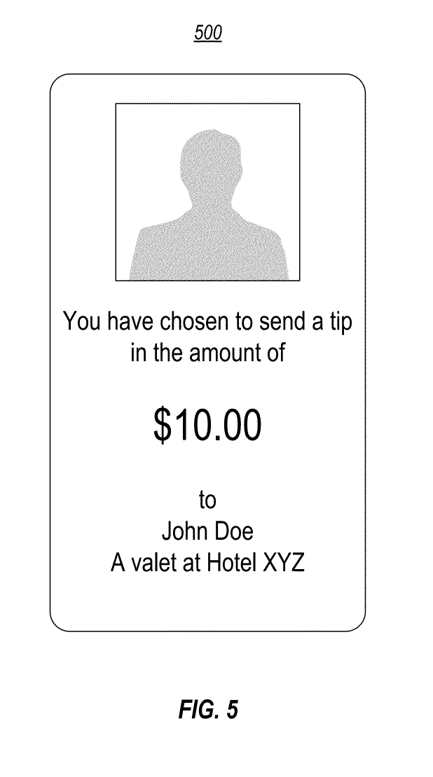

In some embodiments, after the user has selected or specified an amount to tip, the user can be prompted to confirm that the tip should be transferred. In such cases, information regarding the individual to whom the tip will be transferred can be displayed along with the amount to be tipped. FIG. 5 illustrates an example of a user interface 500 that can be displayed to allow the user to provide confirmation prior to initiating the transfer of the tip. As shown, user interface 500 indicates that the user has specified a tip amount of $10. User interface 500 also specifies the name of the individual whose QR code was scanned and the location where the individual works. User interface 500 also displays a picture of the individual. This information about the individual can be obtained in response to the scanning of the QR code and displayed to ensure that the tip will be transferred to the appropriate individual.

In some embodiments, as part of the confirmation process, the user can be prompted to enter a pin. For example, with reference to FIG. 5, user interface 500 can include an option (e.g., a button) to confirm a tip. When such an option is selected, an interface for inputting a pin or other credential can be displayed to require the user to input the pin or other credential before the tip can be processed. Requiring input of the pin or other credential at the confirmation stage can allow the user to more quickly create a tip while still providing security to prevent unauthorized creation of tips.

In some embodiments, a pending tip can be saved. For example, after scanning a QR code or inputting a tip amount, the user may request that the tip be saved for completion at a later time. In response to such a request, the tip information that has already been obtained (e.g., the identifier obtained from scanning the QR code and/or the tip amount) can be stored for later retrieval. After a pending tip has been saved, an option can be provided to allow the user to complete the tip. For example, a mobile application may display an initial screen that includes an option for scanning a QR code to initiate a new tip and an option to complete a saved tip. Upon selecting the option complete a saved tip, the stored information can be repopulated to allow the tipping process to be resumed.

In some embodiments, an application can further be configured to generate or update an expense report when the user provides a tip electronically. For example, if the user provides a tip of $5 using his smart phone, the application can automatically document the amount of the tip to facilitate reimbursement or tax deductions.

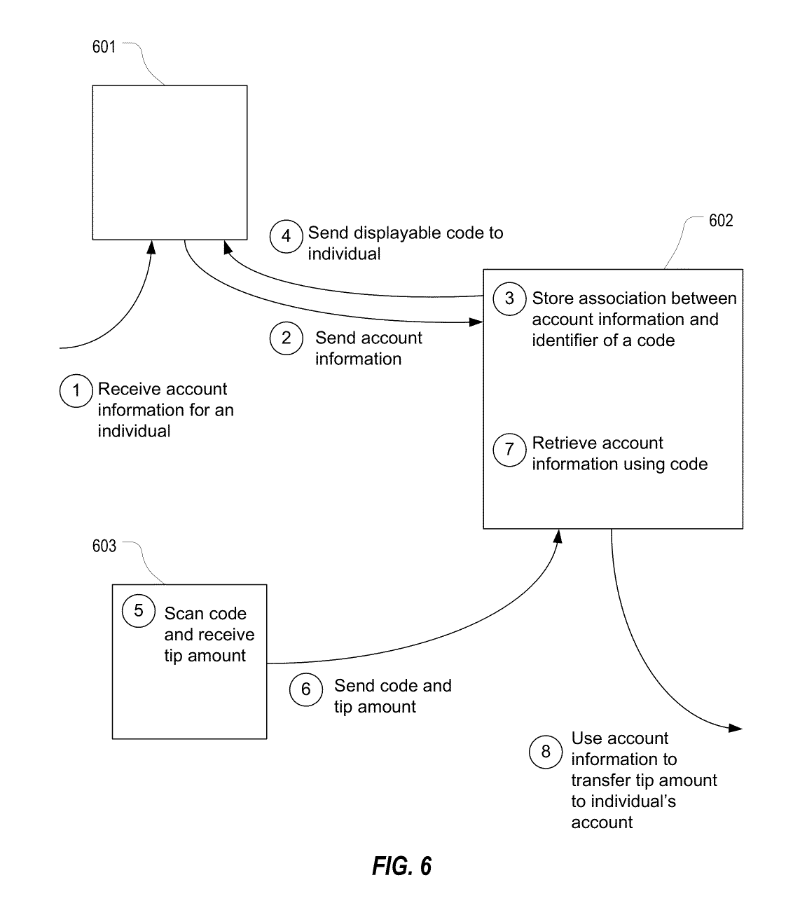

FIG. 6 illustrates a flowchart of an example process of creating an association between a QR code and an individual's account information (steps 1-4) and then using this association to transfer a tip to the individual's account (steps 5-8). This process is shown as being carried out among three computing systems: a user computing system 601, a server system 602, and a smart phone 603. User computing system 601 can represent any device that a user can employ to provide information to server system 602. For example, user computing system 601 can be a smart phone having a custom app or a web browser that receives an individual's account information or a desktop, laptop, tablet, or other computer that employs a browser or other application for receiving the account information. Smart phone 603 can be the same as smart phone 101 described above. In some cases, the same mobile application can be used on user computing system 601 to receive account information and on smart phone 603 to scan a QR code.

In step 1, an individual desiring to receive a code inputs his account information. Account information can include a bank account number and a routing number as well as any other information necessary to transfer funds to the individual's account. Additional information can also be input such as the individual's name, work location, work title (e.g. valet, concierge, etc.), picture, etc. Such information can be useful for providing an interface such as user interface 500 when a QR code is scanned.

Once the account information is input to user computing system 601, in step 2, the account information can be sent to server system 602. In step 3, a code can be generated/associated with the account information. Step 3 can also include generating the displayable version of the code. For example, if the code is a QR code, the identifier (i.e. the actual character value of the QR code) can be stored in a database with a mapping to the account information, and the displayable QR code can be generated. Then, at step 4, the displayable code is transmitted back to user computing system 601.

Once the individual receives the displayable code, it can be displayed (e.g. electronically or by printing the code) where users can view and scan it to provide a tip. Accordingly, at step 5, a user scans the code using a smart phone 603 and inputs a tip amount. In step 6, the scanned code (or more particularly the identifier obtained from processing the scanned displayable code) as well as the tip amount are transmitted to server system 602. In some embodiments, the scanned code can be sent to server system 602 first to allow some information about the individual to be obtained for display to the user on smart phone 603. Then, the tip amount can be transmitted to server system 602. In either case, at step 7, the code is used to retrieve the appropriate account information. Finally, at step 8, the account information is used to initiate the transfer of the tip amount from the user's account to the account associated with the scanned code.

Accordingly, the present invention provides a simple manner for providing a tip to an individual. Unlike other smart phone based transactions that employ QR code scanning, the present invention allows the tipping user to control the transaction including specifying the amount that will be transferred to the individual as the tip. For example, some current systems allow an individual to receive payments using QR code scanning Such systems, however, are inadequate for tipping because they would require the service individual to obtain the tipping user's account information and the tip amount for processing on the service individual's device. In other words, under such systems, the service individual, not the tipping user, controls the transaction. The nature of most services provided by these individuals would not permit the individuals to take the time to perform such transactions. Further, many users would be less likely to allow the individuals to have control over the transaction and would therefore be discouraged from transferring money using such systems.

In contrast to current systems, the present invention would only require the service individual to wear (or otherwise present) a scannable code. The users would then be tasked with scanning the code and completing the tip transaction. The simplicity of the system is therefore ideal for use by a service individual who may not be able to take the time to process a transaction after performing each service, while also minimizing the steps required of the user to provide the tip.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for providing a tip electronically using a mobile computing device, the method comprising:
scanning, by a mobile computing device of a user, a code that is associated with an account of an individual;
displaying, to the user of the mobile computing device, an interface for receiving a tip amount to provide to the individual for services rendered by the individual to the user;
receiving, from the user, the tip amount; and
transferring the code and the tip amount to a server system to request the transfer of the tip amount from an account of the user to the account of the individual that is associated with the code.

2. The method of claim 1, wherein the code is worn by the individual.

3. The method of claim 1, wherein receiving the tip amount comprises receiving the selection of a tip amount displayed in the interface.

4. The method of claim 1, wherein receiving the tip amount comprises receiving manual input of the tip amount.

5. The method of claim 1, further comprising:
in response to transferring the code to the server system, receiving information identifying the individual; and
displaying the information on the mobile computing device in conjunction with a prompt to confirm that the tip amount should be transferred to the individual's account.

6. The method of claim 5, wherein the information includes a picture of the individual.

7. The method of claim 1, further comprising:
prior to transferring the code and tip amount to the server system, storing the code and/or the tip amount.

8. The method of claim 1, further comprising:
prior to transferring the code and the tip amount, prompting the user to input a pin to authorize the transfer of the tip amount.

9. A method for transferring a tip amount from a user's account to an account of an individual using a code associated with the individual, the method comprising:
receiving, from an individual, account information for an account of an individual and information identifying the individual;
generating an association between a code and the account of the individual;
providing the code to the individual to allow the individual to display the code to a user to whom the individual provides services;
in response to a user using a portable computing device to scan the code, receiving the code and a tip amount to transfer from an account of the user to the account of the individual;
transmitting, to the portable computing device, the information identifying the individual to be displayed in conjunction with a request to confirm that the tip amount should be transferred from the user's account to the account of the individual; and
in response to receiving confirmation from the user, causing the tip amount to be transferred from the user's account to the account of the individual.

10. The method of claim 9, wherein the information identifying the individual comprises a picture of the individual.

11. The method of claim 9, wherein the information identifying the individual comprises a role of the individual at a work location.

12. The method of claim 11, wherein the role comprises one of a valet, bellhop, or concierge.

13. One or more computer storage media storing a mobile application, the mobile application comprising computer executable instructions which when executed on a mobile device implements a method for providing a tip to a service individual, the method comprising:
displaying a user interface for capturing a code using a camera of the mobile device, the code being provided by a service individual and being associated with an account of the service individual;
displaying a user interface for receiving user input that specifies a tip amount to provide to the service individual; and
in response to scanning the code and receiving the user input that specifies the tip amount, transmitting the code and the tip amount to a server system to cause the server system to initiate the transfer of the tip amount from an account of the user to the account of the service individual.

14. The computer storage media of claim 13, wherein the method further comprises:
generating an expense report documenting the transfer of the tip amount to the account of the service individual.

15. The computer storage media of claim 13, wherein the user interface for receiving user input that specifies a tip amount comprises one or more default tip amounts that can be selected.

16. The computer storage media of claim 13, wherein the user interface for receiving user input that specifies a tip amount comprises an option to manually input a tip amount.

17. The computer storage media of claim 13, wherein the user interface for receiving user input that specifies a tip amount comprises one or more previously provided tip amounts that can be selected.

18. The computer storage media of claim 13, wherein the method further comprises:
displaying an option to save the code and/or the tip amount.

19. The computer storage media of claim 18, wherein the method further comprises:
displaying an option to retrieve the saved code and/or tip amount.

20. The computer storage media of claim 13, wherein the method further comprises:
prior to transmitting the code and the tip amount, displaying a prompt for the user to input a pin, the pin serving as authorization to initiate the transfer of the tip amount.
